(19) United States
(12) Patent Application Publication
(10) Pub. No.: US 2024/0425278 A1
(43) Pub. Date: Dec. 26, 2024

(54) DELIVERY SYSTEM

(71) Applicant: TOYOTA JIDOSHA KABUSHIKI KAISHA, Aichi-ken (JP)

(72) Inventors: Tatsuya TSUBAKIMOTO, Tokyo-to (JP); Uori KOIKE, Saitama-shi (JP); Yuta ITOZAWA, Nagoya-shi (JP); Takashi IZUMI, Tokyo-to (JP); Satoshi KOMAMINE, Nagoya-shi (JP)

(73) Assignee: TOYOTA JIDOSHA KABUSHIKI KAISHA, Aichi-ken (JP)

(21) Appl. No.: 18/746,043

(22) Filed: Jun. 18, 2024

(30) Foreign Application Priority Data
Jun. 22, 2023 (JP) 2023-102317

(51) Int. Cl. B65G 1/04

(52) U.S. Cl. CPC B65G 1/0492

(57) ABSTRACT

A delivery system capable of efficiently delivering packages is provided. A delivery system includes a mobile robot configured to deliver packages to a storage site, a container disposed in a storage space of the storage site, a transfer mechanism configured to deliver the container holding the package to the storage space or receive the container holding the package from the storage space, and means for performing an operation for increasing the number of empty spaces according to availability of the storage space.

### CROSS REFERENCE TO RELATED APPLICATIONS

This application is based upon and claims the benefit of priority from Japanese patent application No. 2023-102317, filed on Jun. 22, 2023, the disclosure of which is incorporated herein in its entirety by reference.

### BACKGROUND

The present disclosure relates to a delivery system.

Japanese Unexamined Patent Application Publication No. 2022-61816 discloses a technology for placing a package in a locker when the package is delivered to an end user's locker (e.g., smart post) in a vehicle such as an AGV (last-mile delivery).

### SUMMARY

If the locker is full, the package cannot be placed in the locker. Therefore, the vehicle may need to redeliver the package after a vacancy occurs in the locker. As a result, there is a risk that the package cannot be delivered efficiently.

The present disclosure has been made in view of the above circumstances, and an object of the present disclosure is to provide a delivery system capable of efficiently delivering packages.

A delivery system according to the present disclosure includes: a delivery robot configured to deliver a package to a storage site; a container disposed in a storage space of the storage site; a transfer mechanism configured to deliver the container holding the package to the storage space or receive the container holding the package from the storage space; and means for performing an operation for increasing the number of empty spaces according to availability of the storage space.

According to the present disclosure, it is possible to provide a delivery system capable of efficiently delivering packages.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic perspective view for explaining a delivery system;

FIG. 2 is a functional block diagram for explaining a configuration of the delivery system;

FIG. 3 is a schematic diagram for explaining operation examples 1 and 2;

FIG. 4 is a schematic diagram for explaining an operation example 3; and

FIG. 5 is a schematic diagram for explaining operation examples 4 and 5.

### DESCRIPTION OF EMBODIMENTS

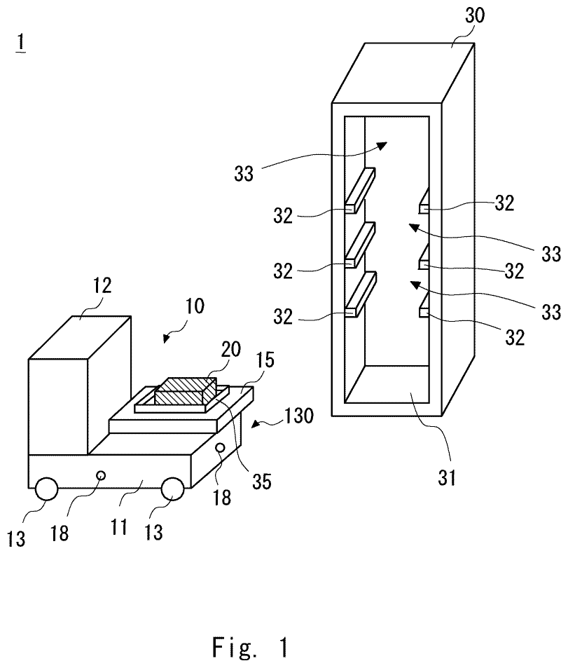

Hereinafter, a delivery system and a method thereof will be described with reference to FIG. 1. FIG. 1 is a schematic perspective view for explaining an overview of the delivery system 1. The delivery system 1 is used for the last-mile logistics, i.e., logistics services from a final base to an end user (also referred to simply as a user). For example, the delivery system 1 is used in a facility with a room and a passage for each user. More specifically, the delivery system 1 is used in an apartment complex such as a condominium or an accommodation such as a hotel.

The delivery system 1 includes a delivery robot 10 and a storage shelf 30. One or more delivery robots 10 travel through the passage of the facility. The storage shelf 30 is installed, for example, in each room of an apartment complex where a user lives. The storage shelf 30 is installed in each dwelling of the apartment complex. The storage shelf 30 serves as a storage site for storing an item 20. For example, the storage shelf 30 is a smart post or a delivery locker. The delivery robot 10 can complete the delivery without the need to hand over the item to the user. For example, if a user purchases the item 20 through online shopping, the delivery robot 10 delivers the item 20 to the user (purchaser) who is the recipient.

The delivery robot 10 sequentially moves and stops in front of the plurality of storage shelves 30 to store the items 20 in the storage shelves 30. This operation can also be referred to as delivery. Further, the delivery robot 10 sequentially moves and stops in front of the plurality of storage shelves 30, retrieves the item 20 from the storage shelf 30, and conveys the retrieved item 20. This operation can also be referred to as collection. The delivery robot 10 (or storage shelf 30) includes a mechanism for delivering items to and from the storage shelf 30. The delivery robot 10 includes various sensors for detecting the storage shelf 30 and obstacles in the passage and can move autonomously. The delivery robot 10 may utilize known object recognition techniques.

The delivery robot 10 delivers the item 20 in a container 35. The container 35 is a tray in which the item 20 is loaded. That is, the delivery robot 10 transfers the item 20 together with the container 35 to the storage shelf 30. The delivery robot 10 retrieves the item 20 together with the container 35 from the storage shelf 30. The container 35 in which the item 20 is loaded is referred to as a holding container, and the container 35 in which the item is not loaded is also referred to as an empty container.

The storage shelf 30 may include a multi-tiered shelf capable of holding items 20. The storage shelf 30 may be installed, for example, on the aisle side of each room in a building or apartment complex. Alternatively, the storage shelf may be located around the entrance of the apartment complex. The delivery robot 10 accesses the inside of the storage shelf 30 from the aisle side to place and retrieve the item 20. A resident (user) accesses the inside of the storage shelf 30 from the inside of the room to place and retrieve the item 20. The storage shelf 30 may have a lockable door on the passage side and the room side. For example, the user U or the delivery robot 10 may lock/unlock the door. Thus, theft of the item 20 or the like can be prevented. The delivery robot 10 may control opening and closing of the door.

The storage shelf 30 has one or more storage spaces 33. Guide rails 32 are provided on both sides of the storage shelf 30. The guide rails 32 are provided along the depth direction of the storage shelf 30. The guide rails 32 support both ends of the container 35. Of course, the configuration for supporting the container 35 is not limited to the guide rails 32, and may instead be a shelf plate, a hook, or a guide groove. The item 20 is a cardboard box or the like in which the purchased item is packed. The storage space 33 can hold the container 35 in which the item 20 is loaded. Since three pairs of guide rails 32 are provided on the storage shelf 30, the storage shelf 30 is divided into three storage spaces 33. Each storage space 33 can store the item 20 together with the container 35. The storage space 33 in which the container 35 is not stored is also referred to as an empty space.

The delivery robot 10 transfers the container 35 in which the item 20 is loaded to the storage space 33. For example, the delivery robot 10 slides the container 35 in the depth direction of the storage shelf 30 with flange parts at both ends of the container 35 resting on the guide rails 32. This enables the delivery robot 10 to transfer the item 20 to the storage space 33 of the storage shelf 30. The user retrieves only the item 20 from the container 35. By using the container 35, the items 20 of various sizes can be easily transferred. In addition, when collecting the item 20, the delivery robot 10 retrieves the container 35 in which the item 20 is loaded from the storage space 33. The delivery robot 10 can collect the empty container 35 in which the item 20 is not loaded.

As shown in FIG. 1, the delivery robot 10 includes a base unit 11 provided with a plurality of wheels 13, a storage unit 12 provided on the base unit 11 (may be collectively referred to as a carriage unit 130) and capable of storing a large number of items 20, and a mounting base 15 provided on the base unit 11 and in which the item 20 is loaded. The base unit 11 may be a substantially rectangular elongated plate-like member. Further, at any location of the delivery robot 10 (base unit 11 in this example), one or more sensors 18 are provided to detect or capture images of objects or the like in the omnidirectional direction of the delivery robot 10 and to detect the positions of obstacles on the road, the positions of storage shelves, and so on. The sensors 18 may be, for example, cameras or LiDAR (Light Detection And Ranging). In addition, the sensor 18 may be provided to detect the presence of a person around the delivery robot 10 or storage shelf 30. The sensors 18 may include a camera for capturing an image of the interior of the storage shelf 30.

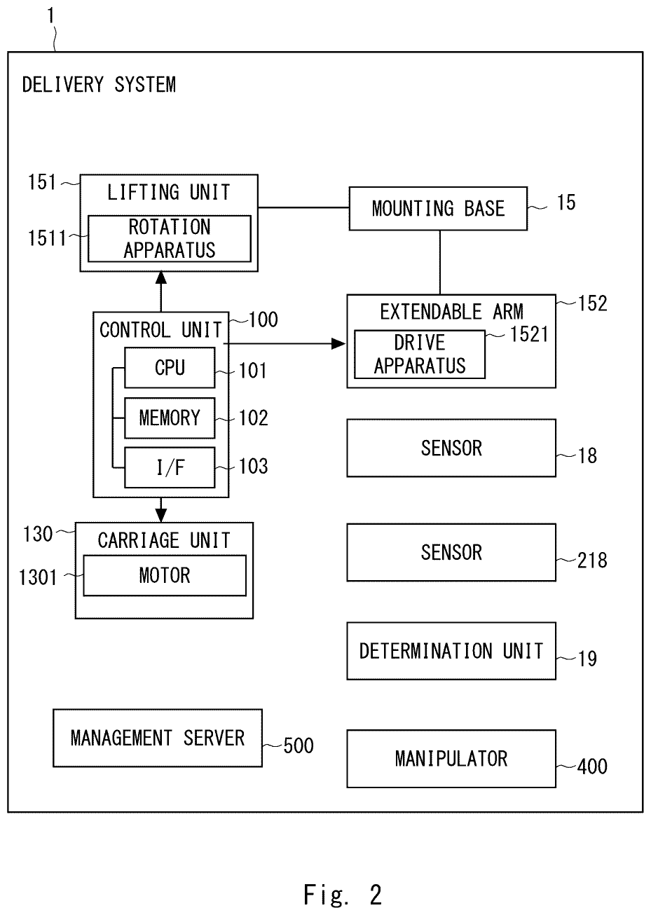

The delivery robot 10 may also use data from a sensor 218 (see FIG. 2) installed outside of the delivery robot 10. The sensor 218 is a surveillance camera installed in the facility. Alternatively, if two or more robots are utilized in the facility, the sensor 218 may be installed in another robot or the storage shelf 30. The delivery robot 10 receives data from the sensor 218 via a wireless network.

The mounting base 15 is provided with a mechanism for loading one item 20 retrieved from the storage unit 12 and storing the item 20 in one desired storage space 33 of the storage shelf 30. The mounting base 15 is provided with an extendable arm (not shown) which can be raised and lowered along the vertical direction and which can be expanded and contracted along the horizontal axis. The extendable arm is configured to be movable forward, backward, left and right. In some embodiments, the mounting base 15 may be configured to be rotatable about a vertical axis. The mounting base 15 may also be configured to be movable in all directions (360 degrees) with the item 20 loaded on it. However, as shown in FIG. 1, since the storage unit 12 is disposed on one side of the base unit 11, the mounting base 15 cannot be moved in a certain direction (also referred to as a rear side in this specification) of the storage unit 12.

The delivery system 1 may be provided with a management server 500 (see FIG. 2) for controlling the travel of the delivery robot 10. In this case, the management server 500 includes a control unit 100 (see FIG. 2) connected to the delivery robot 10 via a network. In another embodiment, functions of the control unit of the management server and the control unit of the delivery robot may be decentralized to implement the present disclosure. The management server 500 may determine the delivery destination and the delivery order, and transmit data indicating the determined delivery destination and delivery order to the delivery robot 10.

FIG. 2 is a block diagram explaining the function of the delivery system 1. The delivery system 1 includes the control unit 100. The control unit 100 may be provided in the delivery robot 10 or the management server 500. The control unit 100 receives sensor signals from the sensors 18 and 218 connected by a wired or wireless network to control the normal operation of the delivery system including a delivery robot such as a carriage unit 130, a lifting unit 151, and an extendable arm 152. In some embodiments, the control unit 100 can control the operation of the door on the front of the storage shelf or a manipulator in it.

The carriage unit 130 includes a base unit 11, a drive wheel 13 (see FIG. 1) rotatably provided on the base unit 11, and a motor 1301 for rotatably driving each drive wheel 13. Each motor 1301 rotates each drive wheel 13 through a reduction gear or the like. Each motor 1301 rotates each drive wheel 13 in response to a control signal from the control unit 100. Each motor 1301 rotates and stops each drive wheel 13 in response to a control signal from the control unit 100, so that the base unit 11 can be moved to and stopped at a specified position. The configuration of the carriage unit 130 is an example and is not limited to this. For example, the number of drive wheels and driven wheels of the carriage unit 130 can be any, and any configuration that allows the base unit 11 to move to any position may be applicable.

As the lifting unit 151 expands and contracts along the vertical axis, the mounting base 15 is lifted and lowered. When the mounting base 15 is raised and lowered, the item 20 can be delivered to the storage space 33 at different heights. The lifting unit 151 includes a rotation apparatus 1511. The extendable arm 152 is attached to the mounting base 15. The extendable arm 152 includes an arm body and a drive apparatus 1521. The drive apparatus 1521 is attached inside the mounting base 15 (not shown) and moves the arm body horizontally. The drive apparatus 1521 may further include a mechanism for rotating the arm body about an axis.

After the lifting unit 151 lifts and lowers the mounting base 15 at the height of the empty space, the extendable arm 152 slides the container 35 along the guide rails 32. This enables the delivery robot 10 to transfer the item 20 and the container 35 to the empty space. After the lifting unit 151 lifts and lowers the mounting base 15 at the height of the desired storage space 33, the extendable arm 152 retrieves the container 35 from the storage space 33. Thus, the delivery robot 10 can retrieve the container 35 and the item 20 from the storage space 33.

The sensor 18 is provided at any location of the delivery robot 10 including the carriage unit 130 and the like. The sensor 18 is, for example, a camera and can acquire a captured image. The sensor 18 can be, for example, LiDAR (Light Detection And Ranging). The sensor 18 can detect the presence of passages, obstacles, people, storage shelves, and so on. The sensor 18 may include a movement detection sensor for detecting the movement of the carriage unit 130 and a height detection sensor for detecting the height of the mounting base 15.

The delivery robot 10 may use data from the sensor 218 installed in something other than the delivery robot 10. The sensor 218 may be a monitoring camera installed in the storage shelf 30, an elevator of a facility, a stairwell, a passage, or the like. Alternatively, if two or more robots are utilized in the facility, the sensor 218 may be installed in a robot other than the robot 10. The delivery robot 10 receives data from the sensor 218 via a wireless network.

The control unit 100 controls the normal operation of the delivery system including the delivery robot, such as the carriage unit 130, the lifting unit 151, and the extendable arm 152. By transmitting a control signal to each motor 1301 of the carriage unit 130, the control unit 100 can control the rotation of each drive wheel 13 and move the base unit 11 to a specified position. The control unit 100 can change the height position of the mounting base 15 by transmitting a control signal to the rotation apparatus 1511 of the lifting unit 151. The control unit 100 can change the horizontal position of the arm body by transmitting a control signal to the drive apparatus 1521 of the extendable arm 152.

The control unit 100 may control the movement of the base unit 11 by performing well-known control such as feedback control and robust control based on rotation information of the drive wheel 13 detected by a rotation sensor provided on the drive wheel 13. The control unit 100 may control the movement of the carriage unit 130, the lifting unit 151, and the extendable arm 152 based on information such as distance information detected by a distance sensor, for example, a camera or an ultrasonic sensor provided on the base unit 11 and map information of the moving environment. The control unit 100 determines a stop position and a stop direction of the delivery robot relative to the storage shelf based on the position of the obstacle detected by the camera and the position of the storage shelf.

The control unit 100 includes, for example, a microcomputer composed of a control program executed by a CPU (Central Processing Unit) 101 for performing control processing, arithmetic processing, etc., a memory 102 composed of a ROM (Read Only Memory) storing arithmetic programs, etc., and an interface unit (I/F) 103 for inputting and outputting signals to and from the outside. The CPU 101, the memory 102, and the interface unit 103 are connected to each other via a data bus, etc.

The determination unit 19 can determine the availability of the storage shelf 30 based on sensor data and the like from the sensor 18 or the sensor 218. For example, the determination unit 19 determines whether or not there is any available spaces in the storage site based on the captured image of the interior of the storage shelf 30. If there is no container 35 in one or more storage spaces 33, the determination unit 19 determines that there is an available space. If there is a container 35 in all the storage spaces 33, the determination unit 19 determines that there is no available space.

The sensor data for determining the availability is not limited to the captured image. As the sensor 18 or 218, various sensors such as a weight sensor, a strain sensor, a contact sensor, an optical sensor, and an infrared sensor can be used. Using the sensor data, the determination unit 19 can detect the presence or absence of the container 35 and the item 20 for each storage space 33. For example, the determination unit 19 may determine the availability based on the sensor data of the weight sensor provided on the shelf plate or the guide rail 32. Alternatively, the availability may be determined using the sensor data of the optical sensor or the infrared sensor provided in the storage shelf 30.

In addition, the determination unit 19 may predict the availability based on the delivery schedule, the collection schedule, and the like. For example, with regard to the storage shelf 30 scheduled for delivery, the empty space decreases until the user who is the recipient retrieves the item 20 after delivery. With regard to the storage shelf 30 scheduled for collection, the empty space decreases until the delivery robot 10 collects the item 20 after the user who is a delivery requester places the item 20 on the storage shelf 30. Therefore, the determination unit 19 may predict the availability based on the schedule information of delivery and collection. In this way, the determination unit 19 can predict the fluctuation of future availability with high accuracy.

At least a part of the processing in the determination unit 19 may be performed by a processor of the management server 500 or the control unit 100. For example, assume that the determination unit 19 is mounted on the delivery robot 10. The delivery robot 10 receives collection and delivery schedule information from the higher-level management server 500. The determination unit 19 can predict the availability of the storage space based on the scheduled collection time, the scheduled delivery time, or the like.

The manipulator 400 is an example of means for increasing the number of the empty spaces in the storage shelf 30. The manipulator 400 may have a robot arm mechanism for holding and transferring the item 20. The manipulator 400 may be installed inside the storage shelf 30 or on the delivery robot 10. The manipulator 400 may be mounted on a mobile robot other than the delivery robot 10. Also, the extendable arm 152 may function as at least a part of the manipulator 400 to increase the number of the empty spaces. Further, the delivery robot 10 may have a manipulator 400 to the number of the empty spaces separately from the extendable arm 152.

The manipulator 400 performs an operation to the number of the empty spaces according to the availability determined by the determination unit 19. For example, when there is no empty space in the storage shelf 30, the manipulator 400 the number of the empty spaces. Alternatively, when it is predicted that there will be no empty space in the storage shelf 30, the manipulator 400 increases the number of the empty spaces. The manipulator 400 may perform an operation to increase the number of the empty spaces by converting one or more storage spaces 33 into empty spaces.

For example, when the delivery robot 10 transfers the item 20 to the storage shelf 30, the determination unit 19 determines whether there is an empty space based on the captured image. When there is no empty space, the delivery robot 10 transfers the item 20 and the container 35 after the manipulator 400 performs an operation to increase the number of the empty spaces. Alternatively, after the delivery robot 10 transfers the item 20 and the container 35 to the last empty space, the manipulator 400 performs an operation to increase the number of the empty spaces to transfer the next item 20. When the last empty space of the storage space 33 is reserved to deliver the item 20, the manipulator 400 may perform an operation to increase the number of the empty spaces.

The operation to increase the number of the empty spaces may be an operation such as sorting the items 20 or collecting the container 35. Sorting the items 20 is an operation to move the item 20 in one container 35 within the storage shelf 30 to another container 35. That is, the sorting operation refers to an operation to move the item 20 within the storage shelf 30 so as to put two or more items 20 together in one container 35. Alternatively, an operation to increase the number of the empty spaces is an operation to collect the empty container or the container in which the item is loaded. By doing so, the system can efficiently distribute items 20 by resolving situations where there is no empty space. Some examples of the operation to increase the number of the empty spaces will be described below.

### Operation Example 1

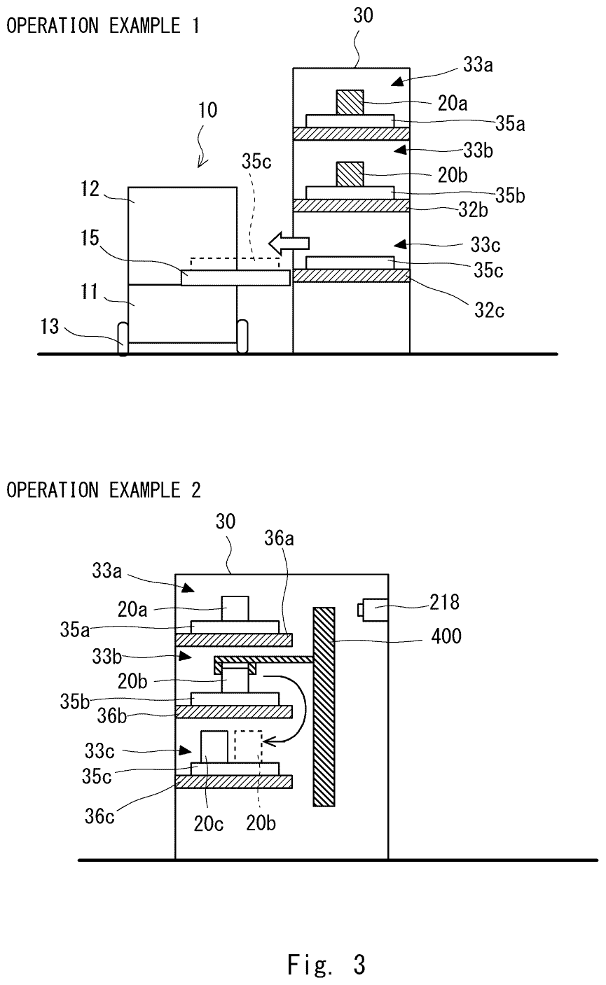

FIG. 3 is a schematic diagram for explaining an example of an operation for increasing the number of the empty spaces, and is a side view schematically showing an internal configuration of the storage shelf 30. In FIG. 3, the storage shelf 30 is provided with guide rails 32a, 32b, and 32c in order from the top. Thus, the storage shelf 30 is provided with storage spaces 33a, 33b, and 33c in order from the top. In the operation example 1, the delivery robot 10 collects one or more empty containers after transferring the item 20.

The storage space 33a has a container 35a holding the item 20a. The delivery robot 10 transfers the container 35b and the item 20b to the storage space 33b. In the storage space 33c, there is a container 35c in which the item is not loaded. When the delivery robot 10 transfers the item 20b and the container 35b to the storage space 33b, the delivery robot 10 retrieves the container 35c, which is an empty container, from the storage space 33c. Alternatively, the delivery robot 10 may transfer the container 35b and the item 20b to the storage space 33b after collecting the container 35c. In FIG. 3, the container 35c retrieved from the storage space 33c is shown with a dashed line. As a result, the storage space 33c becomes an empty space where the next item 20 can be stored. Therefore, the next delivery robot 10 can transfer the container 35 in which the item 20 is loaded to the storage space 33c.

### Operation Example 2

An operation example 2 will be described with reference to FIG. 3. In the operation example 2, the manipulator 400 is disposed in the storage shelf 30. The storage shelf 30 has shelf plates 36a to 36c. Containers 35a to 35c are disposed on the shelf plates 36a to 36c, respectively. The containers 35a to 35c are holding containers which hold items 20a to 20c, respectively. The manipulator 400 moves the item 20b in the storage space 33 to another storage space 33b. The manipulator 400 transfers the item 20b on the container 35b to the container 35c.

Since the container 35b holds a plurality of items 20a and 20b, the container 35c becomes an empty container. Therefore, as in the operation example 1, the delivery robot 10 can collect the empty container 35c in the storage shelf 30. In this case, the delivery robot 10 may not have a manipulator for transferring the item 20 in the storage shelf 30 to another container. When the manipulator 400 transfers the item 20b to the container 35c in the storage shelf 30, the manipulator 400 or the like transmits a command for collection to the delivery robot 10 or the server. For example, the manipulator 400 transmits a radio signal including the command to the delivery robot 10 directly or through the management server 500. The delivery robot 10 moving near the storage shelf 30 stops at the storage shelf 30 to collect the container 35. Thus, delivery can be performed efficiently.

The manipulator 400 may be capable of stacking another container 35a or container 35c on the empty container 35b. That is, a plurality of the containers 35 are stackable. In one storage space 33, the manipulator 400 can place another container 35 on top of the empty container 35. In this case, it is not necessary to transmit a command for collecting the container 35 to the delivery robot 10. That is, the delivery robot 10 arriving at the storage shelf 30 can collect the empty container for the next collection or delivery. Therefore, delivery can be performed more efficiently.

### Operation Example 3

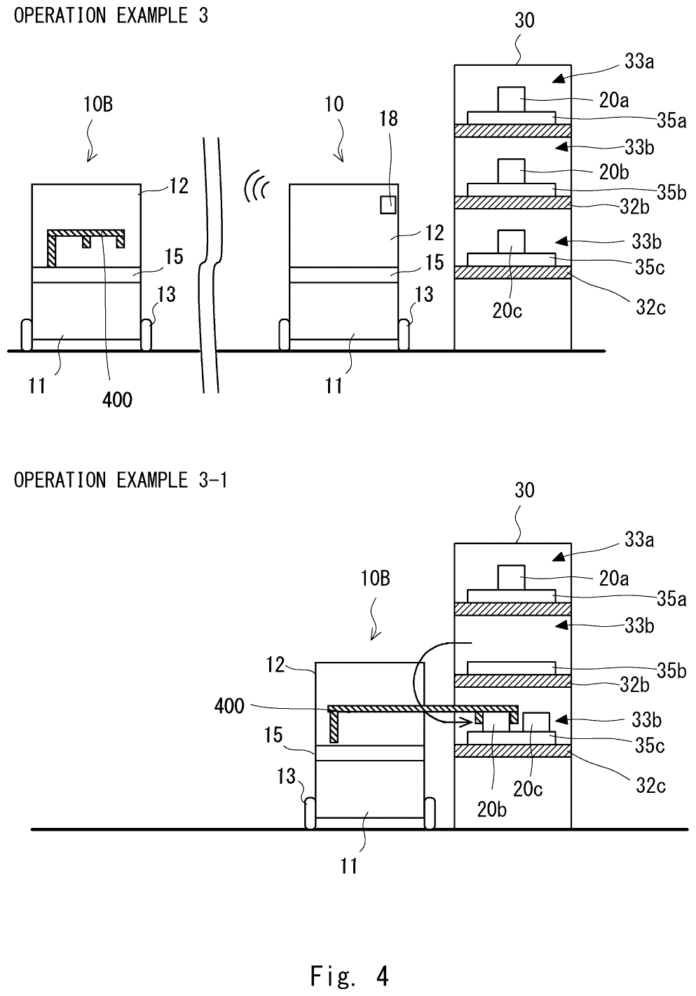

An operation example 3 will be described with reference to FIG. 4. FIG. 4 is a schematic diagram for explaining an example of an operation for increasing the number of the empty spaces, and is a side view schematically showing an internal configuration of the storage shelf 30. In the operation example 3, when the delivery robot 10 transfers the item 20 to the last empty space, the delivery robot 10 cannot collect the empty container. For example, the number of containers that can be loaded in the storage unit 12 is fixed due to the space limitation. Further, since the storage unit 12 is full of containers, there is no available space, and a new container 35 cannot be received. Alternatively, suppose that the delivery robot 10 does not have a manipulator 400 for transferring the item 20 to another container 35. Further alternatively, suppose that the user loads the item 20 for collection in the last empty space.

In such a case, when the container 35 and the item 20 are transferred to the last empty space, the delivery robot 10 transmits a command to another delivery robot 10B to move to the storage shelf 30. The delivery robot 10B has a manipulator 400, and the storage unit 12 of the delivery robot 10B has an empty space. Therefore, the delivery robot 10B, which is heading to the other storage shelf 30, moves to the storage shelf 30 indicated in the command. The manipulator 400 of the delivery robot 10B transfers the item 20 to another container.

For example, when the delivery robot 10 transfers the item 20, the sensor 18 of the delivery robot 10 captures an image inside the storage shelf 30. Alternatively, when the item 20 to be collected by the user is disposed on the storage shelf 30, the sensor 218 provided in the storage shelf 30 captures an image inside the storage shelf 30. Based on the captured image, the determination unit 19 determines that there is no empty space. Then, the delivery robot 10, the sensor 218, the management server 500, and the like transmit a command to the delivery robot 10B including the manipulator 400 to move to the storage shelf 30.

The delivery robot 10B including the manipulator 400 moves to the storage shelf 30. The delivery robot 10B moved to the storage shelf 30 performs an operation to the number of the empty spaces. That is, the delivery robot 10B increases the number of the empty spaces by transferring the item 20 stored in the container 35 to another container 35 or by collecting the empty container 35. Here, as shown in the operation example 3-1, the manipulator 400 of the delivery robot 10B transfers the item 20b from the container 35b to the container 35c. When the items 20b and 20c are put together in the container 35c, the container 35b becomes an empty container, and thus the delivery robot 10B collects the container 35b.

By doing so, it becomes possible to resolve the situation where there is no empty space, and thus the delivery efficiency can be improved. Furthermore, it is not necessary to provide all delivery robots 10 with the manipulators 400. That is, when the delivery system 1 operates a plurality of delivery robots 10, only some of the delivery robots 10 need to have manipulators 400. Therefore, the number of delivery robots 10 with the manipulators can be reduced, thereby reducing the installation cost.

### Operation Example 4

In an operation example 4, the delivery robot 10 conveys the container 35 in which the item 20 is loaded away from the storage shelf 30 to the number of the empty spaces. For example, the delivery robot 10 does not have a manipulator 400 for transferring the item 20 to the container. It is also assumed that the manipulator 400 is not provided in the storage shelf 30. If the container 35 in which the item 20 is loaded is stored in all the storage spaces 33, the delivery robot 10 cannot perform the operation to increase the number of the empty spaces.

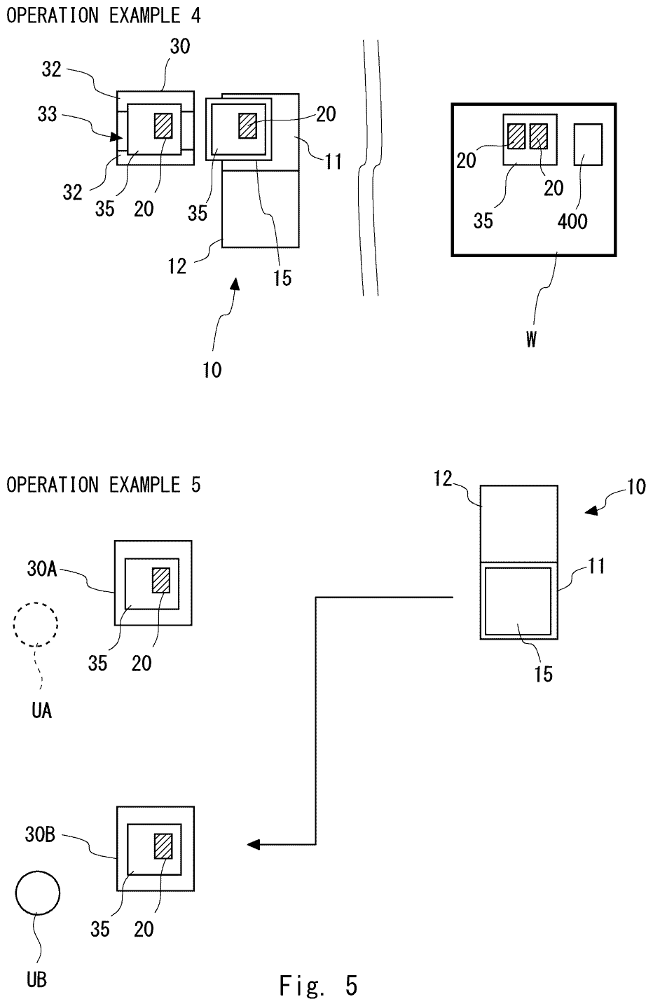

FIG. 5 shows a top view for explaining the operation example 4. The delivery robot 10 retrieves two or more containers 35 together with the item 20. The delivery robot 10 stores two or more containers 35 and the item 20 in the storage unit 12 and moves them to the workshop W. The workshop W is a storage place for temporarily storing the item 20. The manipulator 400 is provided in a workshop W. The manipulator 400 has a robot arm mechanism for putting the two items 20 together in one container 35. Alternatively, the workshop W may have a worker or the like who transfers the items 20. The manipulator 400, the worker or the like puts two or more items 20 together in one container 35. Then, the delivery robot 10 holds the container 35 in which two or more items 20 are loaded in the storage unit 12 and moves to the storage shelf 30. The delivery robot 10 transfers one container 35 to the storage shelf 30.

Two items 20 are loaded in the container 35. Therefore, the storage shelf 30 is in a state where three items 20 are held, and one storage space 33 of the storage shelf 30 becomes an empty space. By doing so, it is possible to improve delivery efficiency by resolving the situation where there is no empty space. Furthermore, it is not necessary to provide all delivery robots 10 with the manipulators 400. Therefore, the number of delivery robots 10 with manipulators can be reduced, thereby reducing the installation cost. For example, when there are a plurality of storage shelves 30 on one floor, one workshop can be provided on one floor.

### Operation Example 5

An operation example 5 will be described with reference to FIG. 5. In the operation example 5, the priority of the operation is set according to the user who uses the storage shelf 30. For example, suppose that a user UA uses the storage shelf 30A and a user UB uses a storage shelf 30B. The user UA is a resident living in the room with the storage shelf 30A and the user UB is a resident living in the room with the storage shelf 30B. Since the user UA is often absent for long periods, the frequency of retrieving the item 20 in the storage shelf 30 is low. On the other hand, since the user UB spends less time at home, the frequency of retrieving the item 20 in the storage shelf 30 is high. In this case, the priority for the storage shelf 30A is set higher than the priority for the storage shelf 30B. Therefore, the delivery robot 10 moves to the storage shelf 30B before the storage shelf 30A and performs an operation to the number of the empty spaces. That is, the delivery robot 10 performs an operation to increase the number of the empty spaces on the storage shelf 30B and then performs an operation to increase the number of the empty spaces on the storage shelf 30A.

The control unit 100 stores user data previously associated with the storage shelf 30 and the user in the memory 102 or the like. The control unit 100 sets a priority according to the user and stores it in the memory 102. Consequently, it prevents the delivery robot 10 from delivering the item 20 to the storage shelf 30 when there is no empty space. Therefore, the delivery system 1 can carry out deliveries more efficiently.

The priority of the operation to the user can be set using various information of the user. For example, based on information indicating whether the user is at home or away, priorities of operations can be set. For users who are at home, they can retrieve items immediately after delivery. Therefore, their priority for the operation is set lower. On the other hand, for users who are away, they may not be able to retrieve items 20 immediately after delivery. Consequently, there is a risk that the item may not be stored if the next delivery occurs, so the priority is set higher. In this way, priorities are set based on information indicating whether the user is at home or away, the duration of absence, the duration of presence, and other relevant factors. Alternatively, priorities can be set based on the user's personality or lifestyle patterns.

It should be noted that the present disclosure is not limited to the above embodiments and can be suitably modified to the extent that it does not deviate from the purpose. In addition, the present disclosure can be implemented by causing a processor such as a CPU (Central Processing Unit) to execute a computer program as part or all of the control processing in the delivery system 1. For example, the control unit 100 or the like can be implemented as an apparatus capable of executing a program such as a central processing unit of a computer. Various functions can also be implemented by a program.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A delivery system comprising:
a delivery robot configured to deliver a package to a storage site;
a container disposed in a storage space of the storage site;
a transfer mechanism configured to deliver the container holding the package to the storage space or receive the container holding the package from the storage space; and
means for performing an operation for increasing the number of empty spaces according to availability of the storage space.

2. The delivery system according to claim 1, wherein the means performs an operation to increase the number of the empty spaces when there is no empty space in the storage space or when there is expected to be no empty space in the storage space.

3. The delivery system according to claim 1, wherein the means increases the number of empty spaces by transferring the package stored in the container to another holding container or by collecting the empty container.

4. The delivery system according to claim 3, wherein the means is a manipulator provided in the storage site and the manipulator increases the number of the empty spaces by transferring the package held in the container to another holding container.

5. The delivery system according to claim 3, wherein when the transfer mechanism transfers the container holding the package to a last empty space in the storage site, the manipulator provided in the mobile robot moves the package disposed in the container to another holding container or collects the empty container.
